(19) United States
(12) Patent Application Publication
(10) Pub. No.: US 2003/0174159 A1
(43) Pub. Date: Sep. 18, 2003

(54) Device, a method and a computer program product for providing support to a user

(76) Inventors: Mats Nordahl, Goteborg (SE); Bengt Johannesson, Goteborg (SE)

Correspondence Address: HARNESS, DICKEY & PIERCE, P.L.C., P.O. BOX 8910, RESTON, VA, 20195, US

(21) Appl. No.: 10/105,160

(22) Filed: Mar. 26, 2002

(51) Int. Cl. G09G 5/00; G06F 15/177; G06F 9/24; G06F 9/00

(52) U.S. Cl. 345/708

(57) ABSTRACT

A device, method and computer program product for providing support to a user in relation to a present support context involving at least one of a computer program and information technology hardware; the device comprising: a processor, input means, output means, and a memory comprising support data items; the processor being configured for investigating the present support context in order to generate a reduced set of support data items, the reduced set being limited to support data items related to the present support context, the reduced set being generated by selecting among support data items in the memory; the selecting being based on the relevance of the support data items in the memory in relation to the present support context; presenting to the user using the output means the reduced set as selectable options; and receiving a user's selection among the selectable options using the input means. The device, the method and the computer program product is used in general purpose computers, personal digital assistants, mobile phones, and other technical equipment including a computer processor.

### TECHNICAL FIELD OF INVENTION

The present invention relates to a number of aspects dealing with providing support to a user in relation to a present support context.

A first aspect of the present invention is related to a device for providing support to a user in relation to a present support context.

A second aspect of the present invention is related to a method for providing support to a user in relation to a present support context.

A third aspect of the present invention is related to a computer program product for providing support to a user in relation to a present support context.

For instance, the present invention is applicable in a general purpose computer, a handheld computers, and a cellular phone.

### BACKGROUND

The need of electronic support in relation to products and services has increased during recent years. Providing support electronically is more cost effective for the provider of the support than providing support using individuals. Also the waiting time, which may be long, for people in need of support can be decreased. Since there is an interactive aspect of electronic support, i.e. often the user has to evaluate questions and answer them, it is often required that the user has a not negligible level of knowledge of the support context. In some cases the support is not adapted for an average person but rather an expert.

### SUMMARY OF THE INVENTION

The purpose of the present invention is to simplify the process of providing support from a user perspective. This is achieved by limiting the user's involvement and increasing the effort of technology. This allows the user to be at a lower knowledge level. Thus the present invention leads to an increased usability. Also, the present invention offers the possibility of a user to receive support without the need of a connection to another computer. Thus it lies within a scope of the present invention that it can be used stand alone.

The present invention is related to a number of aspects dealing with providing support to a user in relation to a present support context. These are presented below.

A device for providing support to a user in relation to a present support context, as presented according to the appended claims 1 to 9.

A method for providing support to a user in relation to a present support context, as presented according to the appended claims 10 to 15.

A computer program product for providing support to a user in relation to a present support context, as presented according to the appended claim 16.

A handheld computer comprising the device according to the above and as presented according to the appended claim 17.

A cellular phone comprising the device according to the above and as presented according to the appended claim 18.

A general purpose computer comprising the device according to the above and as presented according to the appended claim 19.

The aspects are based on the inventive concept of providing support to a user in relation to a present support context involving at least one of a computer program and information technology hardware. The device comprises a processor, input means, output means, and a memory comprising support data items. The processor is configured for performing the following features.

A present support context is investigated in order to generate a reduced set of support data items that contribute to support. The reduced set is limited to support data items related to the present support context. Thus all support data items are not brought to the attention of the user, but only the support data items that are considered relevant in the present support context. This simplifies the use of the present invention since the user does not have to consider more support data items than necessary. The reduced set is generated by selecting among support data items in the memory. This selection is achieved by automatic querying of contents, technical status of, and presence of, hardware and files, such as system management files and drivers. This will be exemplified further below. Thus in the memory there is a number of support data items available to be used in the support providing process and the selecting is based on the relevance of the support data items in the memory in relation to the present support context. This means that support data items not relevant to the user's present support context will not be included in the reduced set.

The reduced set of support data items is presented to the user using the output means. The reduced set is presented to the user as selectable options, in order to facilitate interaction with the user, who will evaluate and then indicate the option that is preferred. Using the reduced set leads to the advantage of being able to offer a device that allows the use of a less skilled person. Another advantage is that it also leads to a faster and shorter process of providing support. Yet another advantage is the increased likelihood of fulfilling the need of the user since the risk of the user selecting a wrong option is decreased. It is not always necessary to communicate an entire support data item, which comprises instructions, or communication, at a more detailed level, to a user, but in some cases it is sufficient to communicate a descriptor of a support data item, i.e. only communicating a part of the support data item. However, in case the user so wishes, the user may request the support data item related to the descriptor.

The user inputs his selection among the selectable options using the input means.

A support data item comprises data of the types of at least one of text and image. The data can be of a number of types; support information to the user, a question to be answered by the user, and selection among alternatives presented.

Support context is here defined as a situation in which a user perceives him, or her, to be in need of support. Examples of support contexts are presented below and as examples in the section presenting preferred embodiments.

In a preferred embodiment of the inventive concept, the processor is configured for receiving, using the input means, a user's indication further indicating the present support context, i.e. in case the user indicates, and thereby further defines, the present support context, the reduced set of support data items will comprise a lower number of support data items. This leads to a more efficient provision of support since the support will be more directed towards a narrower definition of the present support context than otherwise had been possible.

In another preferred embodiment of the inventive concept, the processor is configured for, in case interaction with the user has been indicated unnecessary, automatically responding to the present support context by selecting one of the options. The selected option may be the first option. This leads to decreased interaction with the user, which may be preferred by users not being experts.

In a preferred embodiment of the inventive concept, the processor is configured for automatically responding to the present support context in the case when the reduced set of options consists of only one option. This leads to decreased and simplified interaction with the user, which may be preferred by users not being experts. Also the support process is speeded up.

In another preferred embodiment of the inventive concept, it further comprises a communication unit connectable via a communication network to a server comprising a second database comprising a second set of support data items. This second database comprises support data items that are not of primary relevance, but rather secondary. An advantage of this embodiment is that since all support data items are not of primary relevance, only the support data items considered of higher importance are available without the use of the communication unit, but other support data items are available using the communication unit. Thus this offers the advantage of a user being able to receive support without the need of being online or available via radio communication.

In another preferred embodiment of the inventive concept, the communication network is at least one of the internet and radio communication, i.e. a wireless communication network.

In another preferred embodiment of the inventive concept, the memory comprising support data items is configured for being able to be updated via the communication network. This offers the advantage of the support data items to be updated using the network, which is both fast and cheap.

In another preferred embodiment of the inventive concept, it is arranged in a client computer.

In another preferred embodiment of the inventive concept, the processor is further configured for assisting when installing. This is benificiary in case the output from a support session is for instance that a driver needs to be updated. In this embodiment the driver can be made available from a carrier, such as a CD ROM or a diskette, or it can be made available online or using wireless communication means.

In another preferred embodiment of the inventive concept, the processor is further configured for investigating occurrence of conflicts created by installating. Today's complex computer program installations are in need of a high number of supporting computer files, such as drivers, to be fully operative and in case one of these is not the correct version then it is likely that it will be difficult to make use of the computer program installation or, it will at least be difficult to find out why the computer program installation does not work properly.

According to the first aspect, a device for providing support to a user in relation to a present support context involving at least one of a computer program and information technology hardware is disclosed. Due to the resemblances with the inventive concept described above, this aspect will not be described further here.

According to the second aspect, a method for providing support to a user in relation to a present support context involving at least one of a computer program and information technology hardware is disclosed. Due to the resemblances with the inventive concept described above, this aspect will not be described further here.

According to the third aspect, a computer program product loadable into the internal memory of a computer for performing the method according to the previous aspect is disclosed. Due to the resemblances with the inventive concept described above, this aspect will not be described further here.

Now turning to aspects of applicability of the inventive concept, it is applicable to a number of fields.

1) Handheld computers

2) Cellular phones

3) General purpose computers

In the aspect of the handheld computer, the input means is constituted by at least one of a touch screen and at least one button and the output means is a handheld computer display unit.

In the aspect of the cellular phone, the input means is constituted by an input terminal and the output means is a display unit of a cellular phone.

In the aspect of a general purpose computer, the input means being constituted by at least one of a keyboard and a mouse.

### LEXEME INTERPRETATION

The term support is here considered to include terms such as assistance, trouble shooting and help.

The term information technology is here interpreted broadly. It comprises not only general purpose computers, personal digital assistants, and mobile phones, but also equipment comprising one or more computer processors, or digital signal processors. For instance the processors may be used to control, guide, monitor the operation of equipment, or indicate the technical status of the equipment. For instance and without limitation, the equipment can be used in the fields of forestry, agriculture, energy, and manufacturing equipment.

The term computer program should here be interpreted as a program, or a set of instructions, that can be executed by a processor. This implies that computer programs also can be employed in for instance a handheld computer, or a cellular phone, here considered to be synonym to mobile phone, mobile telephone, and cell phone.

### DESCRIPTION OF THE DRAWINGS

FIG. 1 schematically presents an embodiment of the inventive concept, namely a device for providing support to a user.

FIG. 2 schematically presents an embodiment of the memory comprising support data items.

FIG. 3 schematically presents an alternative embodiment of the inventive concept, namely a device for providing support to a user.

### DESCRIPTION OF PREFERRED EMBODIMENTS

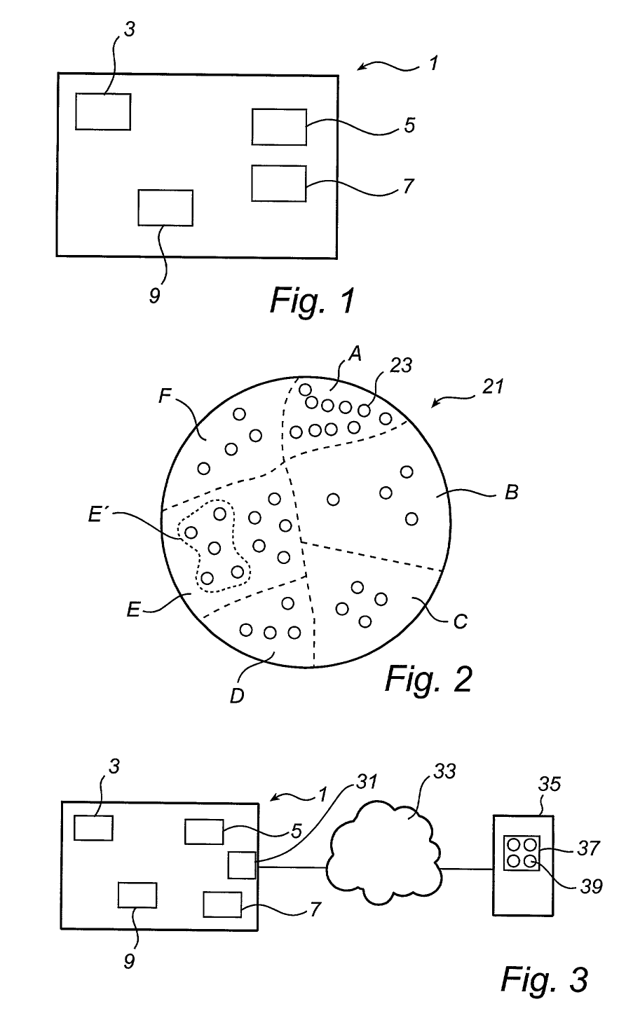

In FIG. 1 a device 1 for providing support to a user in relation to a present support context involving at least one of a computer program and information technology hardware is schematically shown. The device 1 comprises a processor 3, input means 5, output means 7, and a memory 9 comprising support data items. The processor 3 is configured for performing the following.

The present support context is investigated in order to generate a reduced set of support data items. In FIG. 2, a schematic representation 21 of a number of support contexts is shown. An example of a support context is indicated by the letter A in FIG. 2. The support context A is related to a number of support data items 23. In this case the number of support data items is limited to 8 for reasons of simplicity. However, in reality the number is likely to be much higher. Indicative examples of support contexts, or situations in which problems occur, are presented in Table 1 below.

TABLE 1

| reference | Support contexts |
|---|---|
| A | Installation of a new sound card in a PC |
| B | Installation of a new game in a cell phone |
| C | Removal of word processor program |
| D | Installation of a modem |
| E | Use of a handheld computer |
| F | Internet access |

Further examples of present support contexts will be presented below.

Without reducing the number of data support items the user would have to evaluate perhaps all data support items presented in FIG. 2. The reduced set is limited to support data items related to the present support context. Thus the number of support data items is decreased. The reduced set is generated by selecting among support data items in the memory, schematically structured as in FIG. 2. The selecting is based on the relevance of the support data items in the memory in relation to the present support context, i.e. in case a present support context deals with the support context A then only the support data items related to that support context will be in the reduced set. Then the processor 3 is responsive for presenting to the user using the output means 7 the, reduced set as selectable options. Graphically, this can be accomplished by a scroll list or graphical structures responsive to the input means 5. The processor 3 is configured for receiving a user's selection among the selectable options using the input means 5.

In a preferred embodiment the processor 3 is further configured for receiving, using the input means 5, a user's indication further indicating the present support context, i.e. in this embodiment the user is offered an opportunity of actively indicating the present support context resulting in a lower number of support data items 23 in the reduced set. In FIG. 2 this is indicated by E′ within the support context E.

In another embodiment the processor 3 is further configured for, in case interaction with the user has been indicated unnecessary, automatically responding to the present support context by selecting one of the options.

In another embodiment, the processor 3 is configured for automatically responding to the present support context in the case when the reduced set of options consists of only one option.

In another embodiment, presented in FIG. 3, the device 1 further comprises a communication unit 31 connectable via a communication network 33 to a server 35 comprising a second set 37 of support data items 39. In another embodiment the communication network is one of the internet and a wireless communication network.

In another embodiment the device 1 is arranged in a client computer.

In another embodiment the processor 3 is further configured for installing software components, i.e after having indicated the need of installation of one or more e.g. drivers, the device 1 is responsive for the actual installation of the needed drivers.

In another embodiment the processor 3 is further configured for investigating occurrence of conflicts created by the installating in order to avoid problems caused by conflicting versions of computer software components.

As indicated above the present inventive concept is applicable to a number of settings. Indicatice and hypothetical examples of these will be presented below.

1. Problems When Running a New Application

The present support context in this example deals with a user of a personal computer experiences a problem with sound or graphics when trying to run a new application, such as a computer game. After activating of the device, the user indicates that the problem concerns sound (or graphics). In order to generate the reduced set of options, the device executes a set of automated queries and queries to determine the source of the problem. The automated queries carried out by the client program include collecting information about the hardware (sound card/graphics card) installed on the user's machine by actual communication with the hardware, as well as checking relevant information stored on the user's machine in system management files (e.g., in the Windows registry), and information about software installed, such as drivers. The user is presented with a small number of queries to distinguish between alternative hypotheses based on his actual hardware and software configuration. The choice between these is made depending on the symptom encountered, such as no sound, no sound in certain circumstances, etc. It is determined that the driver routine for the hardware device in question needs to be updated to run the new application and this information is communicated to the user. In one preferred embodiment the user is offered assistance in the update procedure, while at the same time checking potential conflicts created by the change and alerting the user to these.

2. A User Learning of a Computer Virus

The present support context in this example deals with a user of a personal computer learns of a new computer virus. The user would like to determine whether the personal computer is vulnerable to the virus. The user invokes the device 1 and it communicates a support data item inquring the supplying of the name of the virus. Then the client program goes through a number of steps dependent on the details of the user's installation to determine the degree of vulnerability in order to generate the reduced set of options. In a particular example for the Windows operating system, this involves first checking the browser version (by reading registry information). Certain browser versions are immune to this particular virus, and the user is immediately presented with this information using the output means. Otherwise the client program checks whether a certain security patch is installed, which also ensures immunity. If this is not the case either, the client programs checks for certain combinations of browser versions and the presence of a particular system file. If none of these conditions are fulfilled, the device 1 indicates to the user that the system is vulnerable to the virus. The likelihood for this is determined from the system information gathered. In this way, the technical information requested from and presented to the user is kept to a minimum.

3. Discovery of a Certain Functionality

The present support context in this example deals with a user of a personal computer discovers that a certain functionality associated with his web browser (e.g., being able to play movies in a certain format, which is accomplished by a particular plug-in) no longer works. The user activates the device 1 on his computer. In order to assist in the generation of the reduced set of options the user indicates that the problem concerns the web browser and graphics. By checking the operating system, web browser version, service packs and other technical information, a finite list of suggestions consistent with this information is built. By further making use of typical problems in this category encountered by other users with closely related installations, a short list of suggestions for the user is constructed. By letting the user answer a small number of queries, the reduced set is even further reduced to a unique explanation. In this case, the cause turns out to be that the program responsible for the desired functionality is in conflict with a service pack that the user has just installed. This particular problem has a solution from the computer manufacturer which involves installing a patch. The client program assists in this installation, which restores the functionality. In this case the user has previously instructed the deive 1 to respond automatically to the present support context and since the reduced set of options consists of only one option, the device 1 solves the problem.

4. A Portable Computer and the Internet

The present support context in this example deals with a user of a portable personal computer experiences a problem with his internet connection. The user uses an ordinary telephone line and a modem. The user in question is only intermittently connected to the Internet due to the mobile nature of his work. He activates the device 1, and informs the program that the problem concerns internet connection. The device 1 is now offline, and cannot access the server and the support database. Some of the information in the database comprising support data items is tagged to always reside in cache, or suitably located elsewhere, on the user's computer, and the device 1 can make use of that part of the support database. The cached information in this case includes all relevant support information on connecting to the internet. The device 1 is invoked and the generation of the reduced set of options by the following. An automated investigative function is used that determine that there is no functioning connection, but that the modem is functioning correctly. The device 1 also takes information from the connection attempts into account. Only a few possible explanations remain when information about the hardware has been considered. The user is presented with a few questions to determine which alternative is correct. In this case, the user has settings stored for a number of different physical locations, and has forgotten to change them according to his current location. The user realizes that this is the problem when given the alternatives. The settings can then be changed by the device 1.

5. Uncertainty of How to Achieve a Result in a Complex Software Application

The present support context in this example deals with a user of a personal computer is uncertain how to achieve a certain kind of result in a complex software application (e.g., a word processor), since the action believed to be correct does not produce the intended result (for example, pasting text into a document causes changes also to the previously existing text in the document). From the viewpoint of the user, when an action does not give the desired result, this could either be the result of ignorance on the user's part or the result of an actual error in the software or installation. Support errands may be due to either type of cause. The user invokes the device 1 and the process of generating the reduced set of options is started. The user indicates that the problem or question concerns the program in question. The device 1 immediately reduces information according to the particular version of the program installed, so that only relevant information and queries are presented to the user. The software manufacturer uses the support system of this application for support, and the device 1 has been provided with some ability to check what actions have been performed in the software application. This information is used to present the user with a small number of likely alternatives instead of presenting a high number of alternatives, as would have been the result without the use of the device 1. The user chooses that which agrees with the perceived problem. It is found that the percieved problem in this case is due to a choice of settings in the application, and can be remedied by changing the settings. The device 1 changes these settings at the user's request, and the problem no longer appears.

6. Internet Service

The present support context in this example deals with a user of an Internet service (such as an Internet bank or shopping site) experiences a problem when using the service, such as not being able to log in, or not being able to carry out certain transactions. The Internet service makes use of the device 1 for its customer support. The user initiates the support session by starting the device 1. The generation of the reduced set of options will now start. After the user indicates that the problem concerns that particular Internet service, the device 1 is arranged to carry out a number of automated queries to determine relevant facts about the user's system configuration, such as operating system, browser and browser settings, system settings such as screen resolution, etc. By using the automatically collected information about the user's system the number of queries to the user about the problem is minimized to a small number. A large database on all problems encountered for all conceivable combinations of systems, browsers and settings is reduced to a small set, the reduced set. It is determined that the reason that the user cannot log in is that he has turned off cookies. Using the service in question requires having cookies turned on. The user is informed of this fact, and presented with an option to solve the problem by turning cookies on by a single click in the support agent window.

7. A Plurality of Categories of Computer Users

The present support context in this example deals with a large company with many different categories of computer users utilizes a support system based on the device 1 of this application for their internal support. The users range from individuals in management that only rarely use their computer to system managers and developers with considerable knowledge and technical skills. This means that the support needs and demands for information differ radically between users. To increase usability by presenting only relevant information to the different categories of users, the company decides to introduce different user categories in the support system. The device 1 can then select and reduce the information presented depending on user category, so that beginner users are not presented with detailed technical information, and technical users do not have to have to search for specific information mixed up with introductory material in their area of expertise. Users can be categorized by hand when they first are given access to the system, or the system can perform automatic categorisation based on already existing users. The system contains an option for allowing users to change their categorization if needed. Automatic categorisation may be used to refine the information presentation further.

8. Personal Digital Assistant

The present support context in this example deals with a user of a personal digital assistant (PDA) or handheld computer deletes an application that is no longer needed on the handheld device. After deleting the application she experiences failures in the synchronization procedure between information stored on the handheld device and information stored on her personal computer. The user invokes a client program based on the device 1 on her handheld device, which in turn instructs the user to connect it to the user's personal computer. A second client program on the personal computer communicates with the support server arranged at a remote location. The process of generating the reduced set of options will now be initiated. After the user indicates that her problem concerns synchronization, the client program determines known sources of synchronization errors for her particular device and configuration from the support database. A small number of queries are presented to the user, and it is determined that an application has recently been erased. By comparing applications installed on the handheld device with secondary modules or databases on the personal computer, the client program finds that the synchronization error is due to certain secondary files not having been erased together with the main application. The user is asked whether she wants to erase the files. She agrees and they are erased, which solves the problem.

9. Mobile Phones

The present support context in this example deals with a support system based on the device 1 is also applicable to support for mobile phones as wireless networks become faster and phones become more complex and their support more resembles computer support. A user of a mobile phone that allows new applications to be downloaded over a wireless network installs a new application that causes a conflict with an application already residing on the user's device. The user activates a support agent including the device 1, which exists in a special thin version for the phone's operating system. Due to the smaller screen area of the phone, it is even more essential to reduce the amount of information presented. After informing the automated support agent that the problem concerns the newly installed application, the client program communicates over the wireless network with the support server and is instructed to check other programs installed and their versions. A potential conflict is identified in the support database as a known problem, and and a solution which involves downloading and installing another version of the application is suggested to the user.

10. Technical Equipment

The present support context in this example deals with a service technician visits a site to investigate an error in a complex piece of techinical equipment controlled by an embedded processor and capable of communicating over a computer network. A wide variety of equipment could fit this description, for instance including devices as diverse as forestry machines and gas chromatographs. The equipment has been designed so that the embedded processor can access a wide range of technical system information. A support client program based on the device 1 runs on the embedded processor, and can access the information from the equipment being controlled, and communicate with the support database at the server. By using the technical information available, the large database of possible errors is narrowed down to a few alternatives. By inspecting the equipment on site, the technician determines the unique cause of the error among the few alternatives presented to him by the system, and fixes the problem.

1. A device for providing support to a user in relation to a present support context involving at least one of a computer program and information technology hardware;
the device comprising: a processor, input means, output means, and a memory comprising support data items; the processor being configured for:
investigating the present support context in order to generate a reduced set of support data items, the reduced set being limited to support data items related to the present support context, the reduced set being generated by selecting among support data items in the memory; the selecting being based on the relevance of the support data items in the memory in relation to the present support context;
presenting to the user using the output means the reduced set as selectable options; and
receiving a user's selection among the selectable options using the input means.

2. A device according to claim 1, wherein the processor is further configured for receiving, using the input means, a user's indication further indicating the present support context.

3. A device according to claim 1, wherein the processor is further configured for, in case interaction with the user has been indicated unnecessary, automatically responding to the present support context by selecting one of the options.

4. A device according to claim 3, wherein the processor is further configured for automatically responding to the present support context in the case when the reduced set of options consists of only one option.

5. A device according to claim 1, further comprising a communication unit connectable via a communication network to a server comprising a second set of support data items.

6. A device according to claim 5, wherein the communication network is one of the internet and a wireless communication network.

7. A device according to claim 1 arranged in a client computer.

8. A device according to claim 1, wherein the processor is further configured for installing software components.

9. A device according to claim 8, wherein the processor is further configured for investigating occurrence of conflicts created at the installing.

10. A method for providing support to a user in relation to a present support context involving at least one of a computer program and information technology hardware;
the device comprising: a processor, input means, output means, and a memory comprising support data items; the method comprising:
investigating the present support context in order to generate a reduced set of support data items, the reduced set being limited to support data items related to the present support context, the reduced set being generated by selecting among support data items in the memory; the selecting being based on the relevance of the support data items in the memory in relation to the present support context;
presenting to the user using the output means the reduced set as selectable options; and
receiving a user's selection among the selectable options using the input means.

11. Method according to claim 10, further comprising
in case interaction with the user has been indicated unnecessary, automatically responding to the present support context by selecting one of the options.

12. Method according to claim 10, further comprising
automatically responding to the present support context in the case when the reduced set of options consists of only one option.

13. Method according to claim 10, wherein the processor is further configured for installing software components.

14. Method according to claim 10, wherein the processor is further configured for receiving, using the input means, a user's indication further indicating the present support context.

15. Method according to claim 10, wherein the processor is further configured for investigating occurrence of conflicts created when installating.

16. A computer program product loadable into the internal memory of a computer, comprising software code portions for performing the steps of claim 10.

17. A handheld computer comprising the device according to one of claim 1, wherein the input means is constituted by at least one of a touch screen and at least one button and the output means is a handheld computer display unit.

18. A cellular phone comprising the device according to one of claim 1, wherein the input means is constituted by an input terminal and the output means is a display unit of a cellular phone.

19. A general purpose computer comprising the device according to one of claim 1, wherein the input means being constituted by at least one of a keyboard and a mouse.
